(19) United States
(12) Patent Application Publication
(10) Pub. No.: US 2014/0050248 A1
(43) Pub. Date: Feb. 20, 2014

(54) I/O CONNECTOR INCORPORATING A COLD JUNCTION

(71) Applicants: Daniel M. Boehme, Owego, NY (US); Mark R. Snow, Ft. Wayne, IN (US)

(72) Inventors: Daniel M. Boehme, Owego, NY (US); Mark R. Snow, Ft. Wayne, IN (US)

(73) Assignee: BAE SYSTEMS CONTROLS INC., Johnson City, NY (US)

(21) Appl. No.: 13/586,497

(22) Filed: Aug. 15, 2012

(51) Int. Cl. G01K 7/13; H01R 43/16

(52) U.S. Cl. 374/181; 29/874; 374/E07.014

(57) ABSTRACT

A thermocouple connection device for terminating a cold junction of a thermocouple includes a housing configured to receive a substrate including an isothermal block positioned within a hollow interior space. Each of a plurality of connection elements include a first portion coupled to a second portion at a cold junction. The cold junction is positioned within the isothermal block such that the first portion and the second portion extend through opposite ends of the substrate. The first portions and the second portions of the connection elements extend through the housing in opposite directions to each other. A first distal end of the first portion is connectable to a control device, and a second distal end of the second portion is connectable to a hot junction. A resistance temperature device (RTD) is coupled to the isothermal block adjacent the cold junctions for measuring a temperature in proximity of the cold junctions.

### FIELD OF THE INVENTION

The present invention generally relates to an input/output connector device, and method related thereto, for terminating a cold junction of a thermocouple device.

### BACKGROUND OF THE INVENTION

A thermocouple is a temperature measuring device that produces a voltage proportional to the temperature difference between two junctions (one hot and one cold) of dissimilar metals. When one junction is either held at a reference (for example, an ice bath) or at a known temperature, the other junction's temperature can be predicted based on the voltage across the circuit and the known temperature of the reference junction. Since holding one of the junctions at a reference temperature outside of the laboratory is not practical, a second temperature measuring device (Resistance Temperature Device, RTD for example) may be used to measure the temperature of the reference junction. RTDs are usually accurate over a narrower temperature range than thermocouples so this junction typically resides within the electronics assembly (inside a full authority digital engine control (FADEC), for example) where the temperature range is more controlled.

Referring to FIGS. 1 and 2, an example id depicted of a known thermocouple device 10 which includes a cold junction module 11 attached to a printed wiring board (PWB) 14. The thermocouple module 11 includes connectors 22 attached to one side of a substrate 15 which is connected to the printed wiring board 14, for example, using a bracket 13. The substrate 15 has connected thereto, isothermal blocks 18 as cold junctions between the PWB 14 and the substrate 15 and attached to the opposite side of the substrate 15 as the connectors 22. Wiring 26 is connected to a control device (not shown), and enters the isothermal block 18 and exits the block 18 to enter the back 21 (shown in FIG. 2) of the connector 22. The wiring 26 exits the front 23 (shown in FIG. 1) of the connector 22 for connection to a hot junction.

One disadvantage of known thermocouple devices using cold junctions, is the amount of time required from a skilled technician to hand wire the cold junction to a connector. Further, the cold junction, connector, and wiring between them, may use a significant amount of real estate on a printed wire board used for supporting the cold junction and the connector, and additionally as a back shell or back plate of the cold junction module 10, as shown in FIG. 1.

### SUMMARY OF THE INVENTION

Therefore, a need exists for a thermocouple device, and a method for providing the thermocouple device, which includes a cold junction module with less parts, and reduces labor time related to wiring of the cold junction.

In an aspect of the invention, a thermocouple connection device for terminating a cold junction of a thermocouple device includes a housing defining a hollow interior space therein configured to receive a substrate positioned within the hollow interior space. The substrate includes an isothermal block. A plurality of connection elements are thermally conductive. Each of the connection elements include a first portion coupled to a second portion at a cold junction. The cold junction is positioned within the isothermal block such that the first portion and the second portion extend through opposite ends of the substrate. The first and second portions of the connection elements extend through the housing in opposite directions to each other parallel to a longitudinal axis passing through a center of the hollow interior space of the housing. A first distal end of the first portion is connectable to a control device, and a second distal end of the second portion is connectable to a hot junction. A resistance temperature device (RTD) is coupled to the isothermal block adjacent the cold junctions for measuring a temperature in proximity of the cold junctions, and the RTD is connectable to the control device.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is an isometric view of a prior art thermocouple device including a cold junction module having a substrate, and the thermocouple device attached to a printed wiring board (PWB);

FIG. 2 is a bottom view of the bottom of the PWB of the prior art cold junction module shown in FIG. 1;

FIG. 3 is an isometric view of a connector according to an embodiment of the invention including a housing and a plurality of connection elements;

FIG. 4 is a detailed isometric view of one of the connection elements shown in FIG. 3;

FIG. 5 is a schematic diagram of a connector in accordance with the embodiment of the invention shown in FIG. 3; and

FIG. 6 is a side elevational view of one of the connection elements shown in FIGS. 3 and 4.

### DETAILED DESCRIPTION OF THE INVENTION

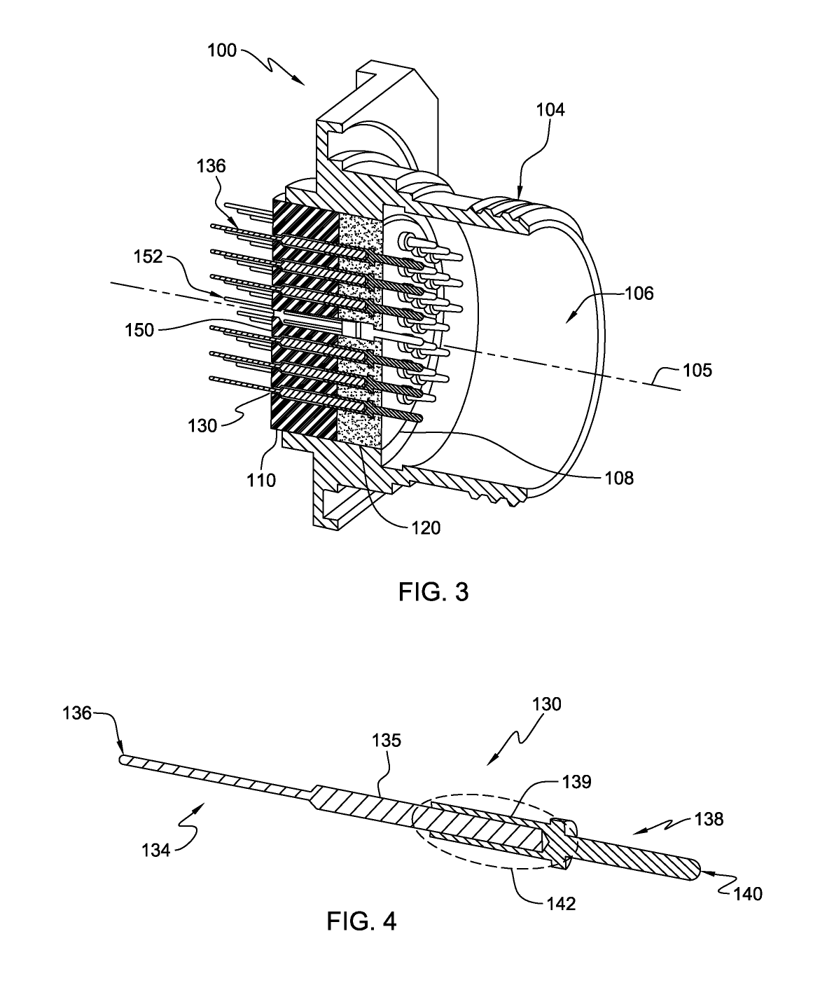

Referring to FIGS. 3 and 4, a thermocouple connector 100 incorporating a cold junction 142 is an embodiment of a thermocouple connection device according to the invention. The connector 100 provides termination for the cold junction 142, and thereby provides an integrated thermocouple device and connector as described in detail below. The connector 100 includes a housing 104 defining a hollow interior space 106 therein, and the housing 104 defines an interior perimeter along a portion 108 of an interior wall of the housing 104. A substrate 110 is positioned within the hollow interior space 106 along the portion 108 of the interior wall of the housing 108 in abutment with the interior perimeter. An isothermal block 120 may be integral with the substrate 110, and in the connector 100 forms a layer over the substrate 110. The isothermal block 120 may be comprised of a conductive material, for example, aluminum.

Referring to FIGS. 3-5, a plurality of connection elements 130 are thermally conductive, and are positioned in the substrate 110 as shown in FIG. 3. Each of the connection elements 130 includes a first portion 134 and a second portion 138. The first portion 134 includes a first distal end 136, and a handle portion 135. The handle portion 135 is coupled to the second portion 138 at a cold junction 142. The cold junction 142 of the connection element 130 is positioned within the isothermal block 120 such that the first portion and the second portion extend through the substrate 110 and the isothermal block 120 opposite one another. The isothermal block 120 helps maintain a known temperature at the cold junction 142. The connection elements 130 extend in the direction of a longitudinal axis 105 passing through a center of the hollow interior space of the housing 104.

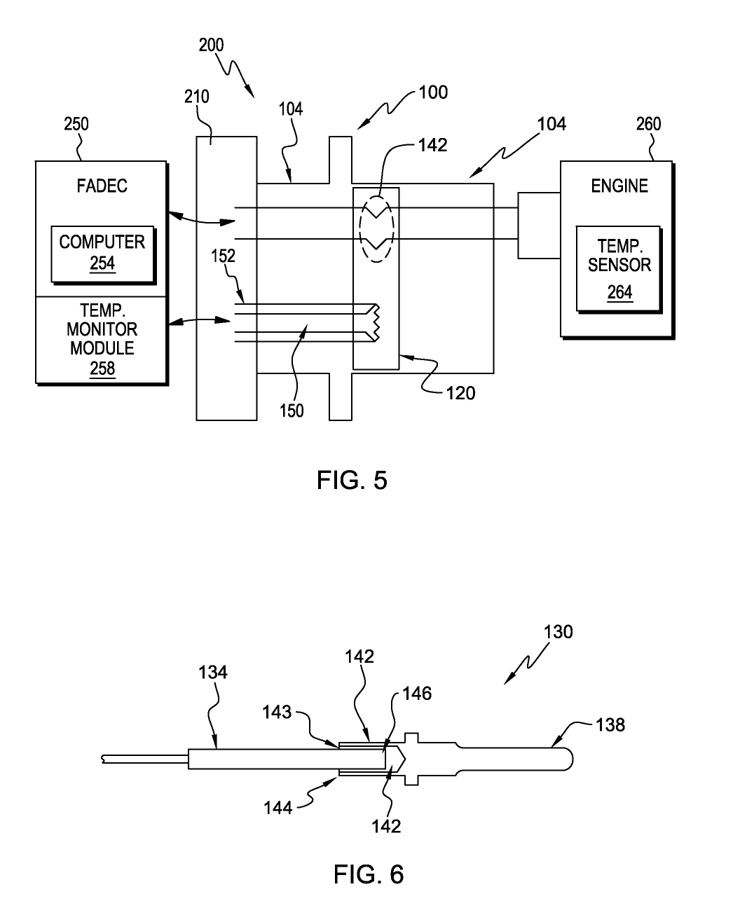

A thermocouple system 200 is shown in FIG. 5 which includes the thermocouple connector 100 connected to a printed circuit board 210 (PCB), communicating with a control device embodied as a full authority digital engine control (FADEC) 250. The first distal end 136 of the first portion 134 is connected to the printed circuit board 210, and in turn, connected to the FADEC 250, which includes a computer 254 (FIG. 5). The computer may include a processor for executing instructions from a program embodied in a computer readable storage device. The computer 254 may be called an electronic engine controller (EEC) or engine control unit (ECU) and controls aspects of engine performance. A second distal end 140 of the second portion 138 is connectable to a hot junction embodied as an engine 260 (FIG. 5). The engine may be, for example, a gasoline engine, turbine engine, or an engine used in a hybrid vehicle.

A resistance temperature device (RTD) 150 is coupled to the isothermal block 120 adjacent the cold junctions 142 as shown in FIGS. 3 and 5, for measuring a temperature in the proximity of the cold junctions. It is advantageous to maintain a constant temperature, which may be a reference or threshold temperature, at the cold junction for measurement accuracy. The RTD may be coupled to a temperature monitoring module 258 (FIG. 5) included in the FADEC 250 for measuring the temperature in the proximity of the cold junctions. The second distal end 140 may be connected to respective temperature sensors 264 on one or more heat generating devices, for example, the engine 260 (FIG. 5).

The connection elements 130 may include specified materials for the first portion 134 and the second portion 138. The first portion 134 may be comprised of copper at the first distal end 136, and Chromel™/Copper at the handle portion 135. The second portion 138 may be comprised of Chromel™ and Alumel™ (Chromel™/Alumel™), wherein Chromel™ is an alloy which may include approximately 90 percent nickel and 10 percent chromium, and Alumel™ is an alloy consisting of approximately 95% nickel, 2% manganese, 2% aluminium and 1% silicon.

Referring to FIGS. 4 and 6, the cold junction 142 of the connection element 130 includes the second portion 138 of the connection element 130 defining a housing 142 having an opening 143 at a terminal end 144 of the second portion 138 (FIG. 6). The first portion 143 has a terminal end 146 configured to fit into the housing 142 of the second portion 138 (FIG. 6).

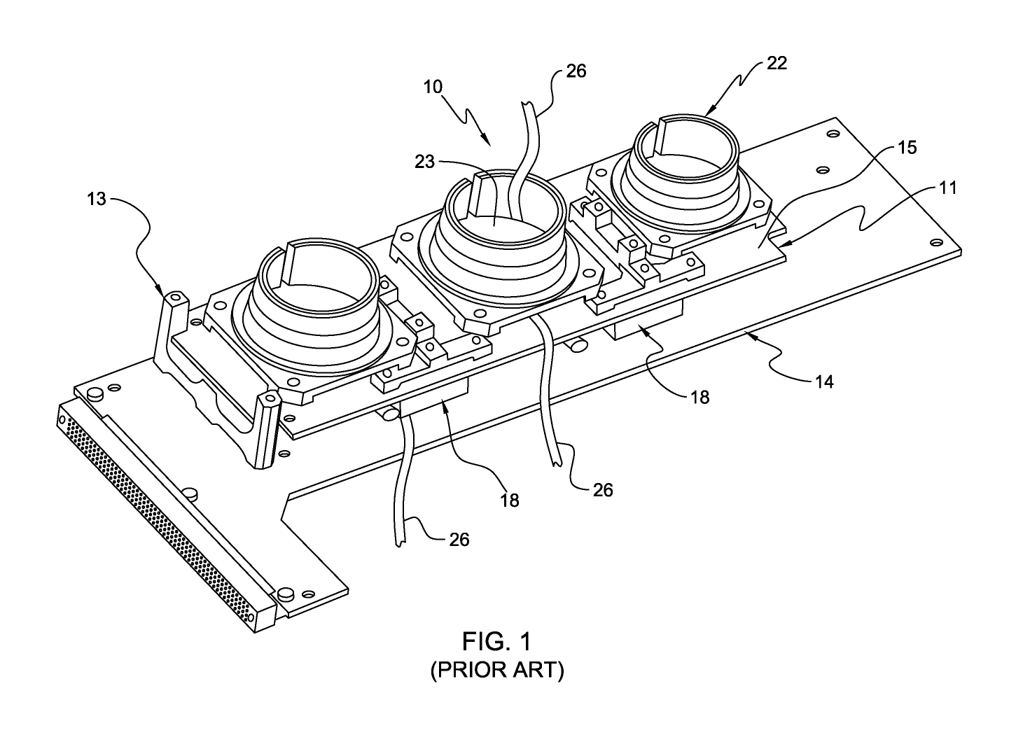

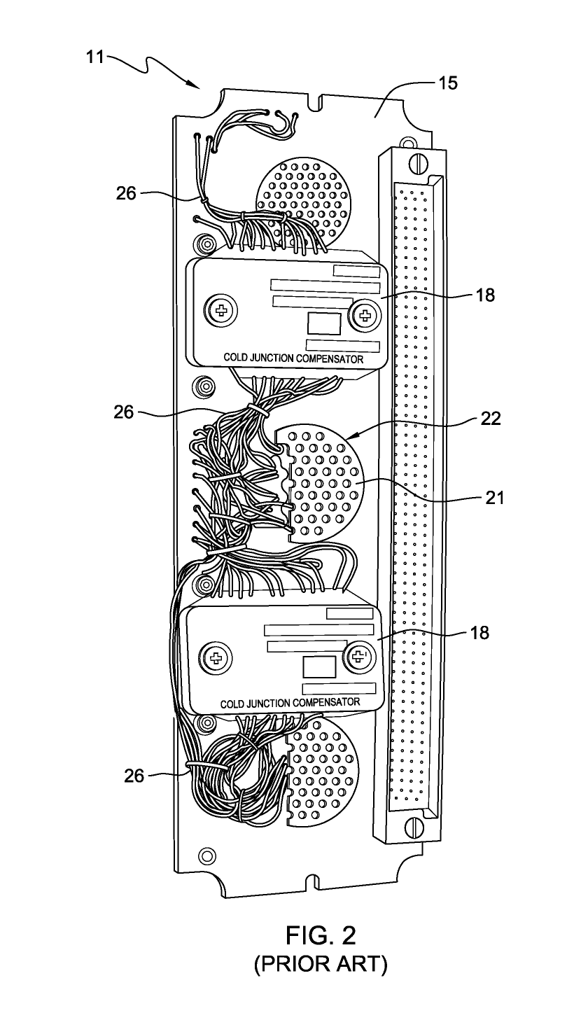

The thermocouple system 200 includes the thermocouple connector 100 for measuring the temperature difference between a junction of dissimilar metals. For example, Type K, Chromel™-Alumel™ may be used and produce a small voltage that is proportional to the temperature difference and measured by the FADEC 250. The cold junction's temperature is better maintained using the isothermal block 120, and is measured using the RTD and the temperature monitor module 258 to measure the thermocouple connector 100 voltage in conjunction with the computer 254 of the FADEC 250, to provide a proportional temperature at the cold junction. The thermocouple connector 100 provides an advantage over the prior art thermocouple modules shown in FIGS. 1 and 2 by reducing the labor time necessary for soldering and wiring.

While the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

What is claimed is:

1. A thermocouple connection device for terminating a cold junction of a thermocouple device, comprising:
a housing defining a hollow interior space therein configured to receive a substrate positioned within the hollow interior space, the substrate including an isothermal block;
a plurality of connection elements being thermally conductive, each of the connection elements including a first portion coupled to a second portion at a cold junction, the first portion and the second portion being of different materials, the cold junction being positioned within the isothermal block such that the first portion and the second portion extend through opposite ends of the substrate, and the first and second portions of the connection elements extend through the housing in opposite directions to each other parallel to a longitudinal axis passing through a center of the hollow interior space of the housing, a first distal end of the first portion being connectable to a control device, a second distal end of the second portion being connectable to a hot junction; and
a resistance temperature device (RTD) coupled to the isothermal block adjacent the cold junctions for measuring a temperature in proximity of the cold junctions, and the RTD being connectable to the control device.

2. The connection device of claim 1, wherein the isothermal block comprises a conductive material.

3. The connection device of claim 2, wherein the isothermal block comprises aluminum.

4. The connection device of claim 1, wherein the RTD is couplable to a temperature monitoring module.

5. The connection device of claim 1, wherein each of the second distal ends of the second portions are connected to respective temperature sensors on one or more heat generating devices as hot junctions.

6. The connection device of claim 1, wherein the first portion of each of the connector elements are coupled to a printed circuit board (PCB).

7. The connection device of claim 1, wherein the first portion and the second portion are each comprised of specified materials.

8. The connection device of claim 1, wherein the first portion of each of the connection elements comprises copper.

9. The connection device of claim 1, wherein the second portion of each of the connection elements comprises Chromel™ and Alumel™, and the first portion comprises Chromel™ and Copper.

10. The connection device of claim 1, wherein the first portion includes a first distal end comprised of Copper, and a handle portion for connection with the second portion.

11. The connection device of claim 1, wherein the second portion includes a second distal end comprised of Chromel™/Alumel™, and a housing portion for connection with the first portion.

12. The connection device of claim 1, wherein the cold junction includes the second portion defining a housing having an opening at a terminal end of the second portion, and the first portion including a first distal end and a handle portion having a terminal end and the terminal end of the handle portion configured to fit into the housing of the second portion.

13. The connection device of claim 1, wherein the housing defines an interior perimeter along an inside wall of the housing, the substrate fills a portion of the hollow interior space and abuts a portion of the inside wall along the interior perimeter.

14. The connection device of claim 1, wherein the control device includes a computer for monitoring a voltage provided by the cold junction of the connection elements, and the control device is connectable to the RTD for monitoring a temperature provided by the RTD.

15. The connection device of claim 1, wherein the first distal end of the first portion of each of the connector elements are coupled to a printed circuit board (PCB) coupled to the housing and between the housing and the control device, the first distal ends electrically communicate with the control device, and the RTD including a connection element connected to the PCB and electrically communicating with the control device.

16. A thermocouple system including a thermocouple connection device for terminating a cold junction of a thermocouple device, comprising:
a housing defining a hollow interior space therein configured to receive a substrate positioned within the hollow interior space, the substrate including an isothermal block;
a plurality of connection elements being thermally conductive, each of the connection elements including a first portion coupled to a second portion at a cold junction, the first portion and the second portion being of different materials, the cold junction being positioned within the isothermal block such that the first portion and the second portion extend through the substrate opposite one another, and the connection elements extend in the direction of a longitudinal axis passing through a center of the hollow interior space of the housing, a first distal end of the first portion being connectable to a control device, a second distal end of the second portion being connectable to a hot junction;
a resistance temperature device (RTD) coupled to the isothermal block adjacent the cold junctions for measuring a temperature in the proximity of the cold junctions;
a control device including a computer connected to the first portions of the connection elements and the RTD, the control device monitoring a temperature provided by the RTD and a voltage provided by the cold junction of the connection elements.

17. The thermocouple system of claim 16, wherein the first distal end of the first portion of each of the connector elements are coupled to a printed circuit board (PCB) coupled to the housing and between the housing and the control device, and the first distal ends electrically communicate with the control device, the RTD including a connection element connected to the PCB and electrically communicating with the control device.

18. A method of providing a thermocouple connection device for terminating a cold junction of a thermocouple device, comprising:
positioning a substrate within a hollow interior space of a housing, the substrate including an isothermal block;
positioning a plurality of connection elements through the substrate, the connection elements being thermally conductive and each of the connection elements including a first portion coupled to a second portion at a cold junction, the first portion and the second portion being of different materials, the cold junction positioned within the isothermal block such that the connection elements extend through the housing in opposite directions parallel to a longitudinal axis passing through a center of the hollow interior space of the housing, a first distal end of the first portion being connectable to a control device, a second distal end of the second portion being connectable to a hot junction; and
coupling a resistance temperature device (RTD) to the isothermal block adjacent the cold junctions, and a connection element of the RTD being couplable to the control device for measuring a temperature in proximity of the cold junctions.

19. The method of claim 18, further comprising:
connecting the first distal end of the first portion to the control device which includes a computer for monitoring a voltage provided by the cold junction of the connection elements;
connecting the control device to the RTD for monitoring the temperature provided by the RTD; and
connecting the second distal end of the second portion to the hot junction.

20. The method of claim 18, further comprising:
connecting each of the second distal ends of the second portion of the connection elements to respective temperature sensors on one or more heat generating devices as hot junctions.
